(19) United States
(12) Patent Application Publication
(10) Pub. No.: US 2013/0166550 A1
(43) Pub. Date: Jun. 27, 2013

(54) Integration of Tags and Object Data

(71) Applicants: Daniel Buchmann, Eggenstein (DE); Thomas Mueller, Wiesloch (DE); Hans-Martin Ludwig, Sandhausen (DE); Florian Kresser, Lobbach (DE); Thomas Finke, Hockenheim (DE); Karl Fuerst, Wiesloch (DE)

(72) Inventors: Daniel Buchmann, Eggenstein (DE); Thomas Mueller, Wiesloch (DE); Hans-Martin Ludwig, Sandhausen (DE); Florian Kresser, Lobbach (DE); Thomas Finke, Hockenheim (DE); Karl Fuerst, Wiesloch (DE)

(73) Assignee: SAP AG, Walldorf (DE)

(21) Appl. No.: 13/333,224

(22) Filed: Dec. 21, 2011

(51) Int. Cl. G06F 17/30

(52) U.S. Cl. 707/736; 707/E17.005; 707/E17.044; 707/E17.058

(57) ABSTRACT

Example systems and methods of integrating data tags with their associated object data are presented. In one implementation, a data object employed in a first computer application is accessed. Examples of the data object include, but are not limited to, structured data and unstructured data. Tagging data that is descriptive of the first data object is also accessed. The tagging data is stored in at least one of the first data object and a separate data object linked with the first data object. The tagging data and the first data object are processed using a second computer application.

### FIELD

The present disclosure relates generally to tagging data, or “tags”, and more specifically, to the integration of tagging data with the object data described by the tagging data to increase the overall functionality of the object data.

### BACKGROUND

Oftentimes, when a computer system user (such as an end user or a user involved more intimately with the design or maintenance of the computer system) accesses data, the user may provide additional data descriptive of the original data being accessed. Typically, this descriptive data is called a “tag” or “tagging data.” Some examples of tagging data include, but are not limited to, user comments regarding the original data, a user rating of the original data, marking of one or more specific portions of the original data, and so on. Typically, this tagging data may be a simple text string providing a comment about the original data, or a typed tag with an associated value (for example, a value of “red” associated with a tag type of “color”).

Depending on the particular environment, the tagging data may be stored separately and reference the original data, or may be attached in some fashion to the original data being described. However, under either scenario, the tagging data collectively represents a “data silo” separate from the original data, as the tagging data typically resides within a different logical “layer” of the environment from the original data, and is thus written, accessed, and viewed as an entity separate from the original data. For example, a particular application that provides and owns a set of original data ordinarily does not foresee or provide any infrastructure for any associated tagging data. As a result, the original data and the tagging data are typically processed or handled by different applications or modules.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of example applications and modules utilized in the enterprise application platform of FIG. 1 for systems and methods of integrating data objects and tagging data;

FIG. 4 is a flow diagram of an example method of integrating data objects and associated tagging data, and the subsequent use of the integrated data;

FIGS. 5A through 5C are block diagrams depicting various example techniques of tagging a data object;

FIG. 6 is a model diagram of an example combined data object and tagging data model;

FIG. 7 is a flow diagram of an example method of generating, configuring, and employing a combined data object and tagging data model;

FIGS. 8A through 8D are model diagrams of example use cases for the preparation, maintenance, and use of tagging data; and

FIG. 9 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

At least some of the embodiments described herein provide various techniques for generating and using tagging data (or, alternatively, data “tags”) that is integrated with one or more data objects. Examples of the tagging data may include, but are not limited to, comments, ratings, categorizations, quantifications, and other characterizations of the data object being tagged.

As is described in greater detail below, a first data object (such as, for example, a business or general-purpose record or file) that is employed in a first computer application is accessed. Also accessed is tagging data that is descriptive of the first data object. As is described below, the tagging data may be provided by a user, or may be generated automatically. The tagging data is stored in at least one of the first data object or a separate data object linked with the first data object such that the tagging data and the first data object may be processed using a second computer application. As a result, the tagging data may be accessed and employed by an application in much the same way as the original data object being tagged, thereby enhancing the value of both the original data and its associated tagging data. Other aspects of the embodiments discussed herein may be ascertained from the following detailed description.

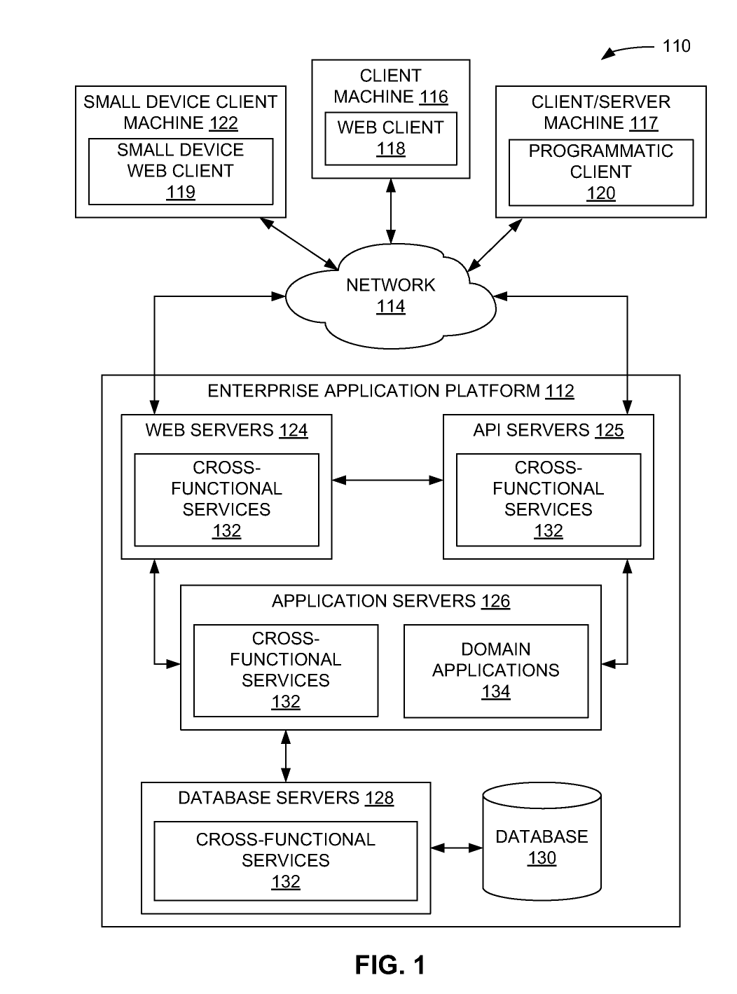

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the INTERNET EXPLORER browser developed by Microsoft Corporation of Redmond, Washington State), a small device client machine 122 with a small device web client 119 (e.g., a browser without a script engine) and a client/server machine 117 with a programmatic client 120.

Turning specifically to the enterprise application platform 112, web servers 124, and Application Program Interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, Application Program Interface (API) servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third party and legacy applications with existing cross-functional services 132 and domain applications 134. Further, while the system 110 shown in FIG. 1 employs a client-server architecture, the present disclosure is of course not limited to such an architecture, and could equally well find application in a distributed, or peer-to-peer, architecture system.

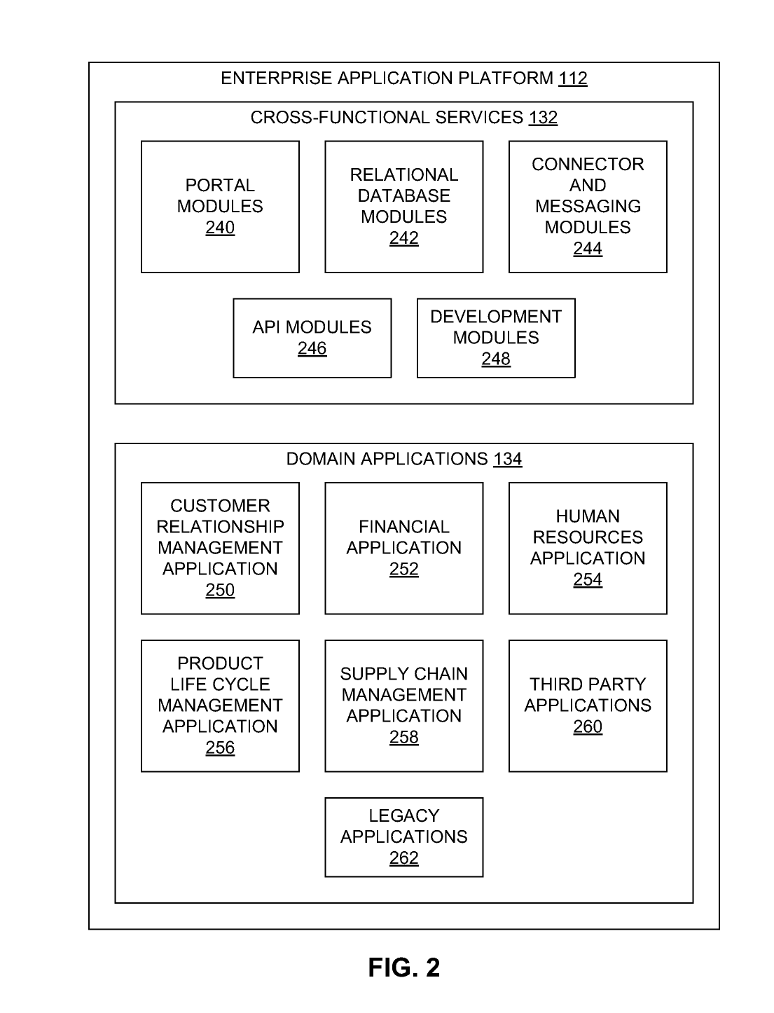

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, Application Program Interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java, J2EE, SAP's Advanced Business Application Programming Language (ABAP) and Web Dynpro, XML, JCA, JAAS, X.509, LDAP, WSDL, WSRR, SOAP, UDDI, and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The Application Program Interface (API) modules 246 may enable the development of service-based applications by exposing an interface to existing and new applications as services. Repositories may be included in the platform as a central place to find available services when building applications.

The development modules 248 may provide a development environment for the addition, integration, updating, and extension of software components on the enterprise application platform 112 without impacting existing cross-functional services 132 and domain applications 134.

Turning to the domain applications 134, the customer relationship management applications 250 may enable access to and facilitate collecting and storing of relevant personalized information from multiple data sources and business processes. Enterprise personnel that are tasked with developing a buyer into a long-term customer may utilize the customer relationship management applications 250 to provide assistance to the buyer throughout a customer engagement cycle.

Enterprise personnel may utilize the financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

The human resources applications 254 may be utilized by enterprise personal and business processes to manage, deploy, and track enterprise personnel. Specifically, the human resources applications 254 may enable the analysis of human resource issues and facilitate human resource decisions based on real-time information.

The product life cycle management applications 256 may enable the management of a product throughout the life cycle of the product. For example, the product life cycle management applications 256 may enable collaborative engineering, custom product development, project management, asset management, and quality management among business partners.

The supply chain management applications 258 may enable monitoring of performances that are observed in supply chains. The supply chain management applications 258 may facilitate adherence to production plans and on-time delivery of products and services.

The third-party applications 260, as well as legacy applications 262, may be integrated with domain applications 134 and utilize cross-functional services 132 on the enterprise application platform 112.

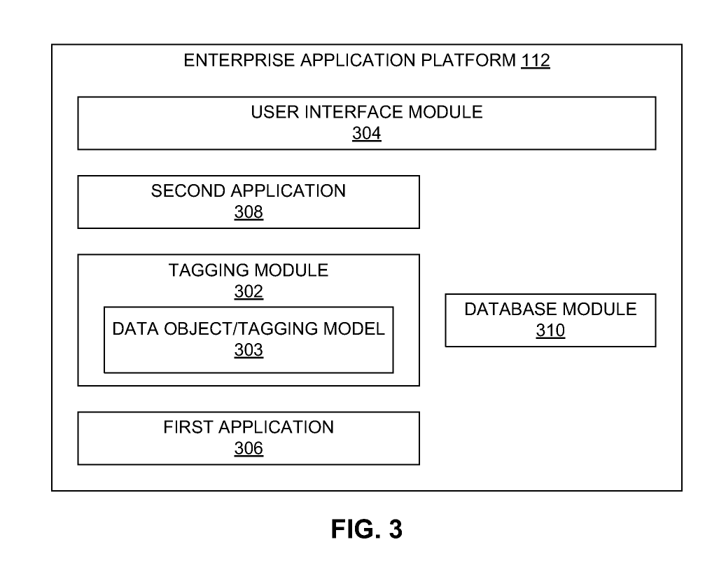

FIG. 3 is a block diagram of example modules employable in the enterprise application platform 112 of FIG. 1 for systems and methods of integrating data objects and tagging data, as mentioned above. In the example of FIG. 3, the enterprise application platform 112 includes a tagging module 302, a user interface module 304, a first application 306, a second application 308, and a database module 310. In some implementations, one or more of these modules may be incorporated in other modules of the enterprise application platform 112. For example, the user interface module 304 may exist as one of the portal modules 240 (FIG. 2), while the database module 310 may be one of the relational database modules 242 (also FIG. 2). Similarly, the first application 306 and the second application 308 may be any of the domain applications 134 (FIGS. 1 and 2). In some examples, the tagging module 302 may be included in the relational database modules 242, a separate module of the cross-functional services 132, or elsewhere. Further, any of the modules 302 through 310 may be combined into fewer modules, or may be partitioned into a greater number of modules.

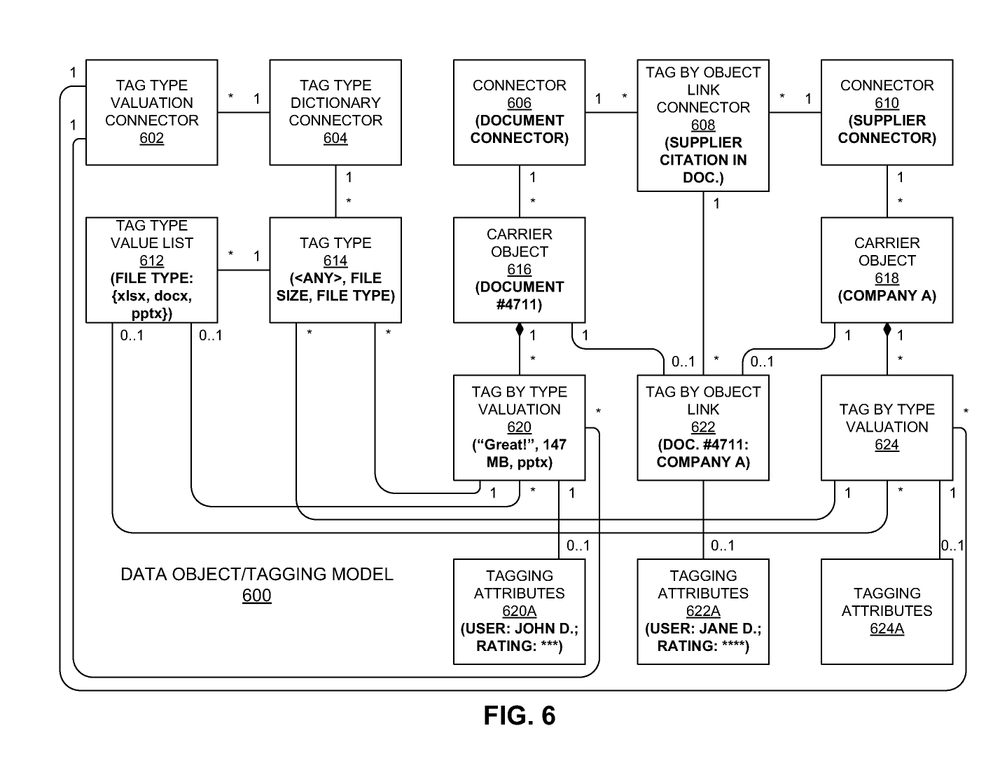

The tagging module 302 may perform any of the functions related to the tagging of data objects, including the generation, storage, maintenance, and/or use of the tagging data. In one example, the tagging module 302 directs or controls such functions via a data object/tagging model 303, an example of which is discussed below in conjunction with FIG. 6. In some examples, the tagging module 302 may be a combination of multiple modules, each of which provides separate functionality regarding the tagging of data objects.

The user interface module 304 may provide a user, such as, for example, an end-user, administrator, content manager, or programmer, access to the tagging data and the associated object data. Such access may include the reading and/or writing of the tagging data and the associated object data, the specifying of possible types of tagging data to be associated with the object data, and other functions requiring access to the tagging data.

The first application 306 may generate and/or use the data object to be tagged. Examples of the first application 306 may include enterprise business applications, such as those depicted as domain applications 134 in FIG. 2. However, any other application capable of being executed on one or more computer processors to generate and/or employ one or more data objects may be represented as the first application 306.

The second application 308 may generate or use the data object and its associated tagging data to provide some computer-related functionality. In some examples, by accessing both the data object and the corresponding tagging data, the second application 308 may be capable of providing greater functionality than what may be possible with accessing the data object alone. In one implementation, the tagging module 302, the first application 306, and the second application 308 may reside in different logical layers of a software hierarchy, with the second application 308 located above the tagging module 302, which is itself located above the first application 306, as shown graphically in FIG. 3. As a result, the first application 306 (possibly along with other applications) may generate data objects, which are accessible via the tagging module 302 to produce the associated tagging data. The second application 308 may then access both the data objects produced by the first application 306 and the tagging data generated by the tagging module 302 to perform some additional function. In some embodiments, both of the first application 306 and the second application 308 may access both the data objects and associated tagging data to perform one or more computer-implemented tasks. Examples of the first application 306 and the second application 308 are discussed below.

The database module 310 may facilitate the storage and retrieval of both the data objects and the tagging data. One example of the database module 310 is a relational database, but any other type of storage facility capable of performing the various storage and retrieval functions commensurate with the various examples discussed below may also serve as the database module 310. For example, the database module 310 may be a data persistency module in which searchable data “indexes”, such as data tables or database “joins” and “views” that store data objects and their associated tagging data. In some cases, such data may be stored in the memory of a server or other system, as opposed to an externally-located database, thus facilitating faster read and write access to the data objects and associated tags.

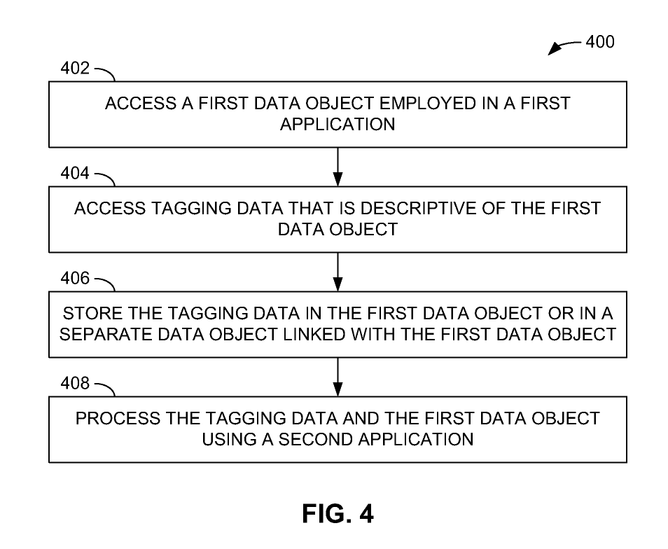

FIG. 4 illustrates an example method 400 of the integration and use of a data object and its associated tagging data. The data object may include, for example, structured data, unstructured data, or both. Generally, structured data may be data that is organized into multiple predefined fields of a record or file. Structured data may also include or be associated with metadata delineating and/or defining the various fields. Examples of structured data may include, but are not limited to, sales invoice records, purchase order records, accounting records, payroll records, database records, spreadsheet files, and other business-oriented data. Conversely, unstructured data is data that is not segmented into predefined fields. Typical examples of unstructured data may include, but are not limited to, word processing files, Portable Document Format (PDF) documents, and web documents (for example, HyperText Markup Language (HTML) files). In some examples, a file may include both structured and unstructured data portions.

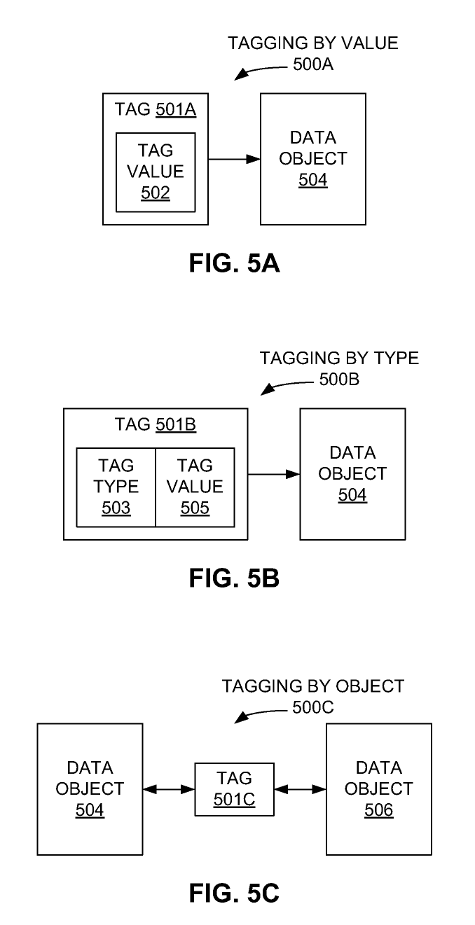

In the method 400, a first data object employed in a first application is accessed (operation 402). The first application, such as the first application 306 of FIG. 3, may be an application which generates and/or otherwise uses the data object. Also accessed is tagging data that is descriptive of the first data object (operation 404). Examples of the types of tagging that may be employed are presented in FIGS. 5A, 5B, and 5C, discussed below.

In some implementations, a user provides or specifies the tagging data, such by way of the user interface module 304 of FIG. 3. For example, the user may employ a user interface that provides input fields for the entry of text, such as comments relating to a particular data object. In other examples, the user interface may provide a predefined number of options for selection by the user for each type of tagging data, such as specific colors, sizes, shapes, viewer ratings, and the like. In another example, the user interface may allow the user to tag the data object by associating the data object with another data object. In other examples, the tagging data may be generated automatically by a computer-implemented process via analyzing or otherwise using the data object to be tagged or other available data, such as by way of text analysis, data mining, and the like.

Continuing with the method 400, the tagging data is stored (operation 406). In an implementation, the tagging data may be stored within the data object being tagged. In another example, the tagging data may be stored in a separate data object that is linked to, logically coupled with, or otherwise references the first data object. The tagging data and the first data object may then be processed using a second application (operation 408), such as the second application 308 of FIG. 3. Such processing may include, for example, searching for a particular data object among a plurality of data objects, navigating across one or more data objects, adding additional tagging data to other data objects, and the like.

While the operations of the method 400 of FIG. 4 and other figures provided herein are shown in a specific order, other orders of operation, including possibly concurrent execution of at least portions of one or more operations, may be possible in some implementations.

In one example, the first application involving the method 400 may be an application that generates text stored in the data objects, such as a word processing application, a spreadsheet program, or the like. The second application may be a search application providing a mechanism by which a user may employ both the data objects and the tagging data to facilitate a more useful and focused search than what may be possible via the data objects alone. In one example, the second application may be viewed as being located in a higher logical level of an application hierarchy above the first application, thus allowing the second application (in this case, a search application) the visibility to access both the data objects and their associated tagging data, as discussed above with respect to FIG. 3. In at least one example, such use of the data object in association with its corresponding tagging data is facilitated by providing the tagging data together with the data object (as opposed to storing the tagging data in its own data silo, completely separated from the data object) so that a single application may employ both types of data to perform a particular task.

Each of FIGS. 5A through 5C depicts a different method of tagging according to various embodiments. For example, FIG. 5A illustrates an example of “tagging by value” 500A, in which a tag 501A, including a tag value 502, references a data object 504 that the tag value 502 describes. The tag value 502 may be a simple character string, such as a comment that describes some aspect of the data object 504, in one example. The tag value 502 is not restricted by being associated with a particular value. Thus, the type of content that may be used for the tag value 502 may be virtually unlimited.

FIG. 5B provides an example of “tagging by type” 500B. In this example, a tag 501B describing the data object 504 includes a tag value 505 that is associated with a particular tag type 503. In some examples, the tag value 505 may be restricted to one of a list of predetermined values specifically associated with the tag type 503. For example, for a tag type 503 of “size” associated with a data object representing a shirt, the possible tag values 505 for this tag type 503 may be limited to “small,” “medium,” “large,” and “extra-large.” A potential advantage of using tagging by type 500B is that some semantic context is provided by restricting the number of options allowed for the tag value 505 to facilitate the process of providing the tag 501B. Similarly, the additional content provided by the tag type 503 facilitates a more focused meaning for the associated tag value 505, which provides for better results in some computer-related tasks, such as searching. In one example, tagging by value 500A may be considered as a specific case of tagging by type 500B, in which the tag type 503 may be considered as “any” type, thus not restricting the associated tag value 505 to a particular format or list of potential values.

FIG. 5C illustrates an example of tagging by object 500C. More specifically, a tag 501C serves as a link between the first data object 504 and a second data object 506. As a result, the first data object 504 is being tagged using the second data object 506, and/or vice-versa. For example, the first data object 504 may represent a particular product, while the second data object 506 represents or contains a written product specification for the product. In one example, the tag 501C may be a bidirectional (or undirected) link, so that a user or an application, having accessed one of the data objects 504, 506, may then access or reference the other of the data objects 504, 506 using the tag 501C to navigate from one to the other. In other examples, the tag 501C may be a unidirectional link, thus allowing navigation from only the first data object 504 to the second data object 506, or vice-versa. In yet other implementations, the tag 501C may couple or link more than two data objects together, thus allowing navigation among any of the linked objects.

In some examples, each of the tags 501A, 501B, and 501C may be implemented as a data object separate from the one or more data objects associated with the tag 501, as shown in FIGS. 5A, 5B, and 5C, or the tags 501 may be stored in at least one of the data objects 504, 506 corresponding to the tag 501. Also, multiple tags 501, possibly of different types, may be associated with one data object 504 in at least some implementations.

Depending on the type of tagging to be performed, more than one of the tagging formats 500A, 500B, and 500C may be employed for a particular tag. For example, tagging a document file represented by a data object 504 with the name of an author can be accomplished by any of tagging by value 500A (by using the name of the author as a tag value 502), tagging by type 500B (by using the name of the author as a tag value 502, and a tag type 503 of “author”), and tagging by object 500C (by using a tag 501C to link the data object 504 for the document with a second data object 506 representing the author). In some implementations, the tagging module 302 (FIG. 3) may determine which tagging format 500A, 500B, 500C should be employed for a particular tagging instance, thus relieving the user from the burden of deciding which format 500A, 500B, 500C to use.

By integrating multiple types of tagging data with the data objects, as noted above, relationships between and among the data objects may be made more freely, either automatically, by way of user input, or both, depending on the particular implementation, thus allowing more effective access and use of the data objects.

FIG. 6 illustrates an example Unified Modeling Language (UML) class diagram model 600 depicting data objects integrated with associated tagging data, with particular examples of the data objects and tagging data noted in bold characters. In the specific examples, the data objects involved are a first carrier object 616 for a document and a second carrier object 618 representing a supplier of the document. However, many other implementations for integrating data objects and tagging may be utilized in other embodiments.

In the model 600, a number of software connectors 602 through 610 may facilitate communication between the various data objects, tagging data, and associated data structures, and one or more applications or modules. As shown in FIG. 6, a tag type valuation connector 602 facilitates communication with tag-by-type valuations 620 and 624, which include “tagging by type” tagging data for the first carrier object 616 and the second carrier object 618. The tag type dictionary connector 604 facilitates communication with a tag type structure 614, which identifies the tag types employed in the tag-by-type valuations 620, 624. Also coupled to the tag type structure 614 is a tag type value list 612 that provides to the tag type structure 614 the possible options or values for any tag types associated with specific, predefined values for each tag type.

Connectors 606 and 610 are connectors for the first carrier object 616 and the second carrier object 618, respectively. Each of these connectors 606, 610 is communicatively coupled with a tag-by-object link connector 608, which facilitates communication with a tag-by-object link 622 linking the first carrier object 616 and the second carrier object 618.

Each of the tagging data objects 620, 622, 624 is coupled with a tagging attributes object 620A, 622A, 624A, respectively. Each of the tagging attributes objects 620A, 622A, 624A provides additional information regarding the tagging data itself, such as, for example, a user that has provided the tagging data. In one implementation, the data attributes include an identity of the user and a rating regarding the effectiveness of the user as a provider of tagging information. In one implementation, this information may be regarded and employed as tagging data describing the provider of other tagging data.

In the specific example emphasized in FIG. 6, a document (“Document #4711”) is represented by the first carrier object 616, while a supplier of the document (“Company A”) is represented by the second carrier object 618. The connectors 606, 610 associated with document and the supplier thus facilitate access to the document and information regarding the supplier, respectively.

Each of the document object 616 and the supplier object 618 are coupled to tagging data in tag-by-type valuations 620, 624, respectively. In the data object/tagging model 600 of FIG. 6, tagging by value is represented as a special case of tagging-by-type; thus, no explicit tagging-by-type data structures are provided.

The tag-by-type valuation 620 for the document includes three separate tags: a comment (“Great!”), a file size (“147 MB”), and a file type (“pptx”). The types associated with each of the tags of the valuation 620 are defined in the tag type structure 614. More specifically, the comment is of a type “<any>,” which essentially is an unclassified type, similar to the tagging by value discussed above. The file size value (“147 MB”) is associated with the “file size” type denoted in the tag type structure 614. This particular tag type can be any value useful as a file size, and thus is not limited to a particular set of values. The file type value (“pptx”), on the other hand, is selected from a list of values specifically associated with the “file type” type. This list is defined in the tag type value list 612 coupled to the tag type structure 614. More specifically, the file type is associated with three distinct values: xlsx, docx, and pptx. In this case, the pptx value is selected for the tag-by-type valuation 620 to indicate the file type of the document.

As mentioned earlier, the tagging data may be generated by a user, or generated automatically by the tagging module 302 (FIG. 3) or another application or module. In this example, the file type and file size tagging data may be generated by analysis of the carrier object 616 for the document, by the file information associated with the document, or other means. The comment tagging data is data that likely is generated or entered by a user.

The supplier of the document (“Company A”), represented by the second carrier object 618, is also tagged by way of the tag-by-type valuation 624. The details regarding the associated tagging data are not provided in FIG. 6 for brevity.

The document, represented by the first carrier object 616, is also tagged by way of tagging-by-object. More specifically, the tag-by-object link 622 tags the first carrier object 616 by linking the first carrier object 616 with the second carrier object 618 representing the supplier of the document. The link 622 may be explicitly defined by a user, or may be generated automatically, such as when the document (as well as the associated carrier object 616) is created or stored, based on information provided in the document itself, or based on data generated upon the creation or storage of the document.

As shown in the example of FIG. 6, the link 622 may include an explicit named reference to each of the carrier objects 616, 618, although any technique for linking two data structures, such as data pointers, indexes, and the like, may be used to link the carrier objects 616, 618. The link 622 may also be bidirectional in nature, such that the first carrier object 616 may be accessed via the second carrier object 618, and vice-versa. Such navigation may further allow navigation to other data objects, such as other documents provided by the same supplier. From there, tagging data referring to these other documents, such as file types, file sizes, comments, and so on, may be accessed as well. Thus, in some examples, the tagging data and its integration with multiple data objects may allow enhanced navigation and search of the data objects.

Further, the integration of the tagging data of FIG. 6 may allow a second application that is different from the application used to generate the original data objects to perform its associated tasks. For example, while the first carrier object 616 may have been generated by way of a word processing application, the addition of the tagging data (i.e., the tag-by-type valuation 620 and the tag-by-object link 622) may allow a search application to navigate and access many more documents having one or more attributes of interest that are related to the original document in some way.

The specific tagging attributes 620A, 622A associated with the tag-by-type valuation 620 and the tag-by-object link 622, respectively, signify the user associated with each tag 620, 622 (namely, “John D.” and “Jane D.”, respectively), as well as a rating associated with either the user or the tagging data itself (three stars and four stars, respectively). In some implementations, another user may utilize this information to ascertain a confidence level in the tagging data, or to contact the user responsible for the tagging data to retrieve more information regarding the tagging of the associated data object.

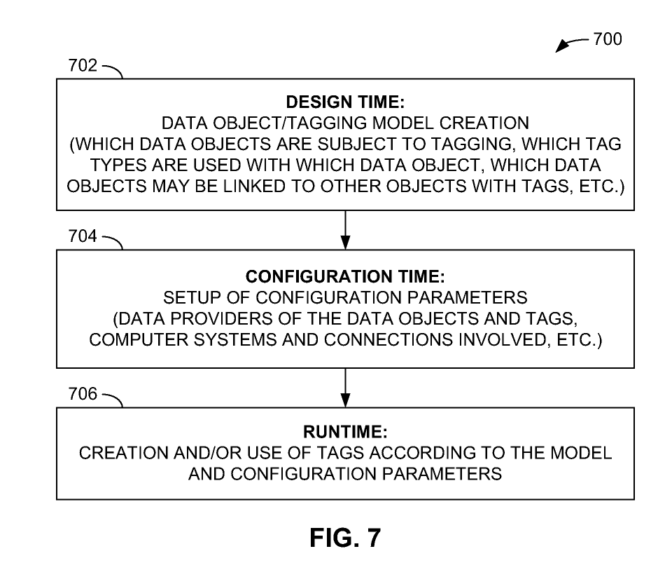

FIG. 7 provides an example method 700 of generating, configuring, and employing a combined data object and tagging data model, such as the model 600 depicted in FIG. 6. During the initial design time of the model (operation 702), the combined data object/tagging model is created. In some examples, few or no restrictions are placed on which tag types are employed, which objects may be tagged, and the like. In other implementations, an individual, such as a system analyst or content manager, or a team of such individuals, may create a model explicitly defining various parameters of tagging data usage, such as tag types and associated tag type value lists that may be used, which data objects may be subject to tagging, which tag types may be used with which data objects, which data objects may be linked to other data objects, and the like.

During configuration of the model (operation 704), various configuration parameters may be defined. An implementation of such parameters may include, for example, identification of the computer systems, data providers, data objects, tagging data, and various connections therebetween by way of the model may be configured. In one particular example, the configuration parameters may allow the linking of files stored on, or accessible via, a test server to business objects of a testing system, but not to business objects of a production system, thus providing a level of security in the generation and use of the tagging data.

At runtime (operation 706), the tagging data associated with one or more data objects is created and stored according to the model previously created and the configuration parameters. Along with the creation and storing of the tagging data, one or more application may employ the tagging data and corresponding data objects to perform one or more tasks, such as searching of the data objects and tagging data, as discussed above.

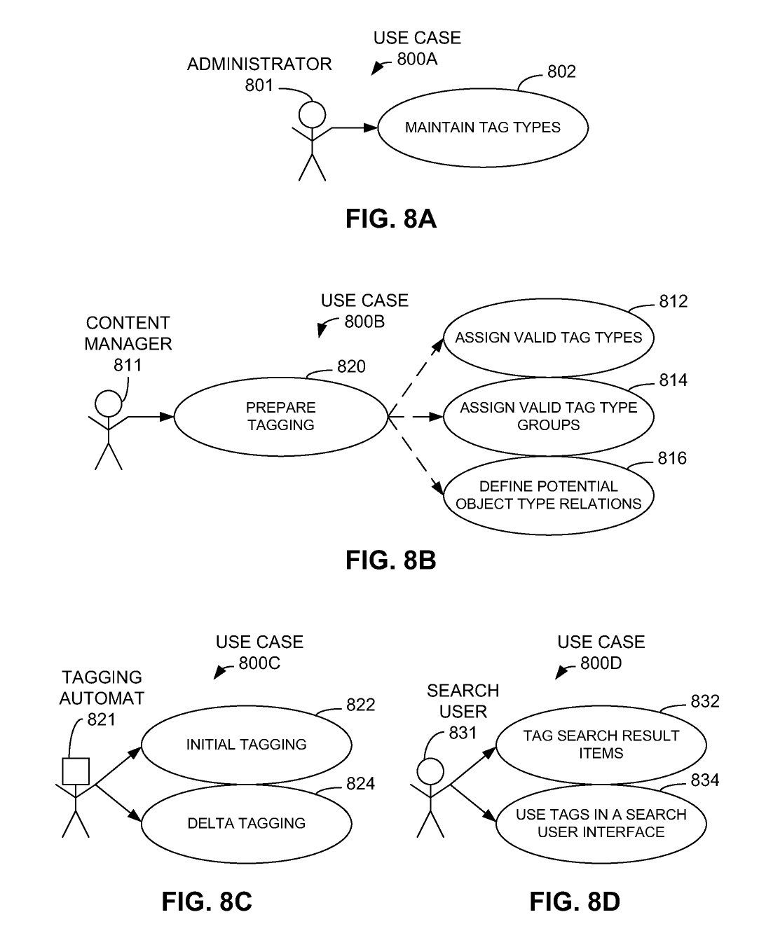

FIGS. 8A through 8D illustrate example use case UML models for various potential user roles associated with a combined data object/tagging model. Generally, these roles involve the preparation, maintenance, and use of the tagging data. While each of the tasks discussed below is identified with a particular individual, team, or system role, assignment of each task to another role is possible in other implementations. FIG. 8A, in one example, depicts the possible role of an administrator 801 in a use case 800A of ongoing maintenance of tag types for the combined data object/tagging model (task 802). In one example, the administrator 801 may update and upload one or more files containing a list of tag types, such as the tag type structure 614 of FIG. 6. In addition, the administrator 801 may provide one or more tag type value lists, such as the tag type value list 612 of FIG. 6.

In some implementations, the administrator 801 may generate and provide one or more tag type groups. Each group may include multiple tag types that are related in some fashion, or that may even be deemed “synonyms” of each other. For example, the name of a particular tag type may have changed over time, even though the newer version of the tag type represents the same tag value information as a preceding version of the tag type. As a result, tag types of the same group may be viewed or searched as though they represent the same tag type.

FIG. 8B depicts a use case 800B involving the role of a content manager 811 to prepare initially prepare the various tag types for use (task 820). As shown in FIG. 8B, the preparation of the tag types may include, for example, defining and/or assigning valid tag types (task 812), defining and/or assigning value tag type groups (task 814), and defining and/or assigning potential object/tag type relations (task 816). In an example, the defining of the object/tag type relations may involve the definition of labels for the various tag types, the specification of how each of the tag types may be used or viewed (for example, for filtering, searching, and other application tasks), and the facilitation of automatic tagging. To enable or promote automatic tagging, the content manager 811 may select attributes of various data objects that contain values relevant for automatic tagging. For example, a “name” attribute of the data object may be used to fill a tag value for a tag associated with the data object.

In FIG. 8C, a use case 800C for a tagging automat 821 may involve either or both of the initial automatic tagging (task 822) and the incremental, or “delta,” automatic tagging of the data objects (task 824). In one example, the tagging automat 821 is a computer-implemented process that automatically performs various tagging operations without user intervention. In initial tagging, automatic tagging, where appropriate, may occur in response to a new data object/tag type relation being specified for preexisting data objects. In response, the tagging automat 821 may automatically tag each affected data object according to the new object/type relation, which may have been specified by the content manager 811 of FIG. 8B. In incremental tagging, the tagging automat 821 may update preexisting tagging data based on changes that have been made to one or more of the data objects. For example, the tagging automat 821 may generate new tagging data for newly generated data objects, delete tagging data for removed data objects, and update tagging data for any data objects that have been revised.

FIG. 8D depicts a use case 800D in which a search user 831 may tag search result items in a user interface provided to the user (task 832) and use the tags in the user interface (task 834). More specifically, in tagging search result items, the search user 831 may use the user interface to specify a value as a tag for a data object (such as in tagging by value), to select a tag type for a data object and either enter a value for the tag type or select a value from a list of tag values associated with the tag type (such as in tagging by type), or to select a specific data object to link with the data object of interest (such as in tagging by object). In using the tags in the user interface, the search user 831 may, for example, specify tag values to perform a search of data objects with matching tags, use tags to filter previous search results, display tags of a data object that resulted from a search, display data objects related to a tag of a displayed data object, and rate a particular tagging or a user associated with that tagging.

In at least some embodiments discussed herein, the integration of tagging data and associated data objects allows both types of data to be accessed and used in a single, cohesive, seamless manner, thus enhancing the use of both the data objects and corresponding tagging data. Such integration may also result in uniform access and presentation of both the data objects and the tagging data, either via a user interface to a user, an API to an application, or other means. More specifically, the integrated tagging data may also facilitate enhanced searching and navigation of the data objects, such as in the example of the document and related supplier discussed above in conjunction with FIG. 6. Applications involving other tasks involving access to either or both of the data objects and related tagging data may be similarly augmented.

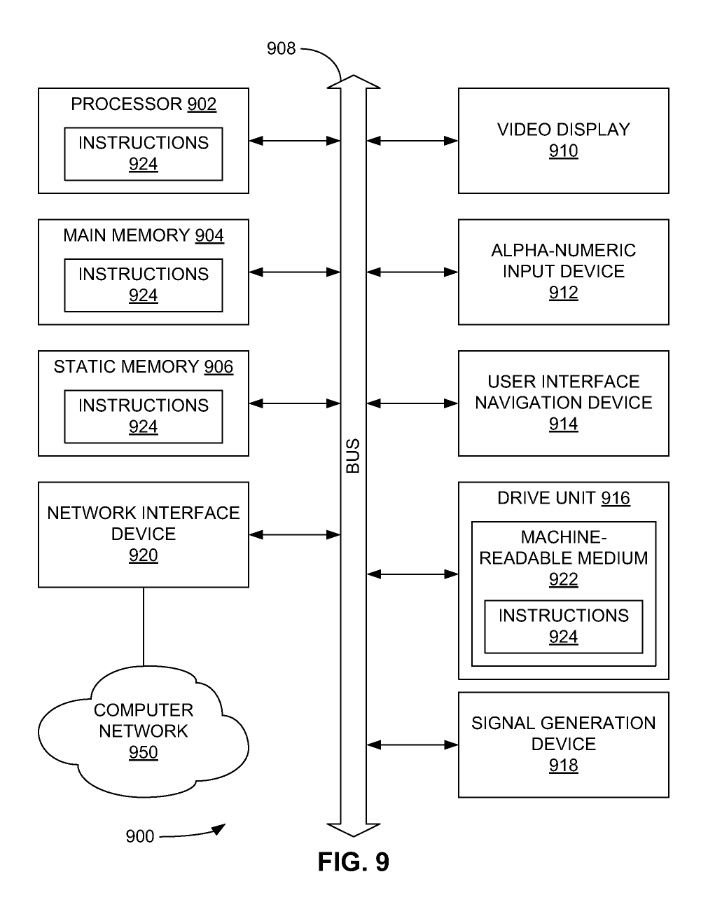

FIG. 9 depicts a block diagram of a machine in the example form of a processing system 900 within which may be executed a set of instructions for causing the machine to perform any one or more of the methodologies discussed herein. In alternative embodiments, the machine operates as a standalone device or may be connected (for example, networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 900 includes a processor 902 (for example, a central processing unit (CPU), a graphics processing unit (GPU), or both), a main memory 904 (for example, random access memory), and static memory 906 (for example, static random-access memory), which communicate with each other via bus 908. The processing system 900 may further include video display unit 910 (for example, a plasma display, a liquid crystal display (LCD), or a cathode ray tube (CRT)). The processing system 900 also includes an alphanumeric input device 912 (for example, a keyboard), a user interface (UI) navigation device 914 (for example, a mouse), a disk drive unit 916, a signal generation device 918 (for example, a speaker), and a network interface device 920.

The disk drive unit 916 (a type of non-volatile memory storage) includes a machine-readable medium 922 on which is stored one or more sets of data structures and instructions 924 (for example, software) embodying or utilized by any one or more of the methodologies or functions described herein. The data structures and instructions 924 may also reside, completely or at least partially, within the main memory 904, the static memory 906, and/or within the processor 902 during execution thereof by processing system 900, with the main memory 904 and processor 902 also constituting machine-readable, tangible media.

The data structures and instructions 924 may further be transmitted or received over a computer network 950 via network interface device 920 utilizing any one of a number of well-known transfer protocols (for example, HyperText Transfer Protocol (HTTP)).

Certain embodiments are described herein as including logic or a number of components, modules, or mechanisms. Modules may constitute either software modules (for example, code embodied on a machine-readable medium or in a transmission signal) or hardware modules. A hardware module is a tangible unit capable of performing certain operations and may be configured or arranged in a certain manner. In example embodiments, one or more computer systems (for example, the processing system 900) or one or more hardware modules of a computer system (for example, a processor 902 or a group of processors) may be configured by software (for example, an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (for example, hardwired) or temporarily configured (for example, programmed) to operate in a certain manner and/or to perform certain operations described herein. Considering embodiments in which hardware modules are temporarily configured (for example, programmed), each of the hardware modules need not be configured or instantiated at any one instance in time. For example, where the hardware modules include a general-purpose processor 902 that is configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 902 that are temporarily configured (for example, by software) or permanently configured to perform the relevant operations. Whether temporarily or permanently configured, such processors 902 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine but deployed across a number of machines. In some example embodiments, the processors 902 may be located in a single location (for example, within a home environment, within an office environment, or as a server farm), while in other embodiments, the processors 902 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

1. A method, comprising;
accessing a first data object that is employed in a first computer application;
accessing tagging data that is descriptive of the first data object;
storing the tagging data in the first data object; and
processing, using at least one processor, the tagging data and the first data object using a second computer application.

2. The method of claim 1, further comprising processing the tagging data and the first data obit using the first computer application.

3. The method of claim 1, the first data object comprising at least one of structured data and unstructured data.

4. The method of claim 1, the tagging data comprising a text string not associated with a tag type.

5. The method of claim 1, the tagging data comprising a tag value and a lag type corresponding to the tag value.

6. The method of claim 1, the tagging data comprising a link coupling the first data object with a second data object.

7. The method of claim 1, further comprising navigating between the first data object and the second data object using the tagging data.

8. The method of claim 1, the accessing of the tagging data comprising:
displaying data of the first data object via a user interface; and
receiving the tagging data via the user interface in response to the displaying of the data of the first data object:

9. The method of claim 8, the accessing of the tagging data further comprising displaying, via the user interface, a plurality of tagging data options, the tagging data being selected from the plurality of tagging data options.

10. The method of claim 1, the accessing of the tagging data comprising:
analyzing the first data object; and
generating the tagging, data based at least on the analyzing of the first data object.

11. The method of claim 1, further comprising:
receiving a data object model integrating definitions of data object types, and definitions of tagging data types to be associated with the data object types, the data object model defining the storage of the tagging data in the first data object.

12. The method of claim 1, the data object model comprising at, least one of:
information indicating at least one tagging data type to be associated with at least one of the data object types; and
information indicating at least two data object types to be linked together via at least one of the tagging data types.

13. The method of claim 1, the second computer application comprising a data search application.

14. A non-transitory computer-readable storage medium comprising instructions that, when executed by at least one processor of a machine, cause the machine to perform operations comprising:
accessing a first data object that is employed in a first computer application;
accessing tagging data that is descriptive of the first data object;
storing the tagging data in the first data object; and
processing the tagging data and the first data object using a second computer application.

15. The non-transitory computer-readable storage medium of claim 14, the first data object comprising one of structured data and unstructured data.

16. The non-transitory computer-readable storage medium of claim 14, the tagging data comprising one of a text string not associated with a tag type, a tag value and a tag type corresponding to the tag value, and a link coupling the first data object with a second data object.

17. A system comprising;
at least one hardware processor; and
modules Comprising instructions that are executable by the at least one hardware processor, the modules comprising:
a database module to store a first data object;
a first application module to process the first data object;
a tagging module to access tagging data that is descriptive of the first data object, and to store via the database module the tagging data in the first data object; and
a second application module to process the tagging data and the first data object.

18. The system of claim 17, further comprising a user interface module to display data of the first data object and to receive the tagging data responsive to the display of the data of the first data object.

19. The system of claim 17, the tagging module to analyze the first data object and to generate the tagging data based at least on the analyzing of the first data object.

20. The system of claim 17, the first data object comprising one of a structured business data object and an unstructured data file.
